(19) United States
(12) Patent Application Publication
(10) Pub. No.: US 2023/0174399 A1
(43) Pub. Date: Jun. 8, 2023

(54) WATER TREATMENT METHOD, WATER TREATMENT DEVICE AND SLIME INHIBITOR FOR MEMBRANES

(71) Applicant: ORGANO CORPORATION, Tokyo (JP)

(72) Inventor: Shohei YAMAMOTO, Tokyo (JP)

(73) Assignee: ORGANO CORPORATION, Tokyo (JP)

(21) Appl. No.: 17/912,702

(22) PCT Filed: Jan. 27, 2021
(86) PCT No.: PCT/JP2021/002716

§ 371 Date: Sep. 19, 2022

(30) Foreign Application Priority Data
Mar. 24, 2020 (JP) 2020-053019

(51) Int. Cl. C02F 1/76; B01D 65/06; B01D 65/08; B01D 61/58; B01D 61/04; B01D 61/16; C02F 1/44; C02F 1/68

(52) U.S. Cl. CPC C02F 1/766; B01D 65/06; B01D 65/08; B01D 61/58; B01D 61/04; B01D 61/16; C02F 1/441; C02F 1/444; C02F 1/686; B01D 2317/025; C02F 2305/02; C02F 2303/185; B01D 2321/168; B01D 2317/08; B01D 2311/12; B01D 2311/04; B01D 2311/06; B01D 2311/22; B01D 2311/2626; B01D 2311/2623

(57) ABSTRACT

The present application provides a water treatment method, a water treatment device, and a slime inhibitor for membranes that are capable of, in water treatment using a separation membrane and a reverse osmosis membrane in the subsequent stage, inhibiting the generation of a slime both in the separation membrane and in the reverse osmosis membrane by a simple method. The water treatment method includes adding an iodine-based oxidizer to water to be treated, subjecting the water to be treated obtained during the adding of the iodine-based oxidizer to filtration with the separation membrane, and causing filtrated water obtained during the filtration to be separated with the reverse osmosis membrane into permeated water and concentrated water.

### TECHNICAL FIELD

The present invention relates to a water treatment method that employs a separation membrane and a downstream reverse osmosis membrane, a water treatment device, and a slime inhibitor for membranes.

### BACKGROUND

The use of various antibacterial agents (slime inhibitors) as a method for suppressing biofouling (slime inhibition) in water treatment methods that use separation membranes such as reverse osmosis membranes (RO membranes) is already well known.

Patent Document 1 discloses that by introducing iodine that is a reaction product of sodium hypochlorite and potassium iodide into a reverse osmosis membrane, biological contamination of the reverse osmosis membrane can be suppressed. Further, Patent Document 2 discloses a performance recovery treatment method for a semipermeable membrane that includes adding an iodine-containing solution containing added iodine and/or an iodine compound to a water to be treated.

### CITATION LIST

### Patent Literature

Patent Document 1: JP S56-033009 A
Patent Document 2: JP 2011-161435 A

### SUMMARY

### Technical Problem

Separation membranes (turbidity removal membranes) composed of a precision filtration membrane or ultrafiltration membrane are sometimes used as a pretreatment for a reverse osmosis membrane, but as a result of slime generation on the separation membrane, slime may sometimes develop on the reverse osmosis membrane downstream from the separation membrane even when an antibacterial agent is introduced into the reverse osmosis membrane device, or the amount added of the antibacterial agent may need to be increased. Further, when sodium hypochlorite is used to pretreat the separation membrane using the method disclosed in Patent Document 1, and dechlorination is attempted by using only potassium iodide in the treated water, there is a possibility that the dechlorination may not occur completely, meaning some sodium hypochlorite may flow into the reverse osmosis membrane and cause membrane degradation.

An object of the present invention is to provide a water treatment method, a water treatment device and a slime inhibitor for membranes which, when used in a water treatment that employs a separation membrane and a downstream reverse osmosis membrane, are capable of inhibiting slime generation in both the separation membrane and the reverse osmosis membrane by a simple method.

### Solution to Problem

The present invention provides a water treatment method that includes an iodine-based oxidizing agent addition step of adding an iodine-based oxidizing agent to a water to be treated, a filtration treatment step of subjecting the water to be treated obtained in the iodine-based oxidizing agent addition step to a filtration treatment using a separation membrane, and a reverse osmosis membrane treatment step of separating the filtration treated water obtained in the filtration treatment step into a permeate and a concentrate using a reverse osmosis membrane.

In the above water treatment method, the iodine-based oxidizing agent preferably contains water, iodine and an iodide.

In the iodine-based oxidizing agent addition step of the above water treatment method, the total iodine CT value (mg/L·h) represented by (total iodine within the water to be treated (mg/L))×(iodine-based oxidizing agent addition time (h)) is preferably not more than 1.25 (mg/L·h).

In the iodine-based oxidizing agent addition step of the above water treatment method, intermittent addition is preferably performed by providing an addition period during which the iodine-based oxidizing agent is added to the water to be treated, and a non-addition period during which the iodine-based oxidizing agent is not added to the water to be treated.

In the above water treatment method, it is preferable that the addition period is a continuous period of at least 10 seconds but not longer than 3 hours, and the non-addition period is a continuous period of at least 5 seconds but less than 48 hours.

In the above water treatment method, the membrane pore size of the separation membrane is preferably 0.01 μm or greater.

The above water treatment method preferably also includes an iodine removal step of removing iodine components from within the permeate.

In the above water treatment method, in the iodine removal step, at least one of activated carbon and an anion exchanger is preferably used.

The present invention also provides a slime inhibitor for membranes which contains water, iodine and an iodide.

In the above slime inhibitor for membranes, the pH is preferably at least 3 but not more than 9.

In the above slime inhibitor for membranes, total iodine is preferably at least 3% by mass.

In the above slime inhibitor for membranes, the molar ratio of the iodide relative to the iodine is preferably within a range from 1 to 1.9.

The present invention also provides a water treatment device containing an iodine-based oxidizing agent addition unit for adding an iodine-based oxidizing agent to a water to be treated, a filtration treatment unit for subjecting the water to be treated obtained in the iodine-based oxidizing agent addition unit to a filtration treatment using a separation membrane, and a reverse osmosis membrane treatment unit for separating the filtration treated water obtained in the filtration treatment unit into a permeate and a concentrate using a reverse osmosis membrane.

In the above water treatment device, the iodine-based oxidizing agent preferably contains water, iodine and an iodide.

In the above water treatment device, the iodine-based oxidizing agent addition unit is preferably configured so that the total iodine CT value (mg/L·h) represented by (total iodine within the water to be treated (mg/L))×(iodine-based oxidizing agent addition time (h)) is not more than 1.25 (mg/L·h).

In the above water treatment device, the iodine-based oxidizing agent addition unit is preferably a unit that performs intermittent addition by providing an addition period during which the iodine-based oxidizing agent is added to the water to be treated, and a non-addition period during which the iodine-based oxidizing agent is not added to the water to be treated.

In the above water treatment device, it is preferable that the addition period is a continuous period of at least 10 seconds but not longer than 3 hours, and the non-addition period is a continuous period of at least 5 seconds but less than 48 hours.

In the above water treatment device, the membrane pore size of the separation membrane is preferably 0.01 μm or greater.

The above water treatment device preferably also contains an iodine removal device for removing iodine components from within the permeate.

In the above water treatment device, the iodine removal device is preferably at least one of activated carbon and an anion exchanger.

### Advantageous Effects of Invention

By employing the present invention, a water treatment method, a water treatment device and a slime inhibitor for membranes can be provided which, when used in a water treatment that employs a separation membrane and a downstream reverse osmosis membrane, are capable of inhibiting slime generation in both the separation membrane and the reverse osmosis membrane by a simple method.

### BRIEF DESCRIPTION OF DRAWINGS

FIG. 1 is a schematic structural diagram illustrating one example of a water treatment device according to an embodiment of the present invention.

FIG. 2 is a schematic structural diagram illustrating another example of a water treatment device according to an embodiment of the present invention.

FIG. 3 is a schematic structural diagram illustrating yet another example of a water treatment device according to an embodiment of the present invention.

FIG. 4 is a schematic structural diagram illustrating yet another example of a water treatment device according to an embodiment of the present invention.

FIG. 5 is a schematic structural diagram illustrating yet another example of a water treatment device according to an embodiment of the present invention.

FIG. 6 is a graph illustrating the change over time in a value obtained by subtracting the initial water flow differential pressure (kPa) from the actually measured water flow differential pressure (kPa) in Test Example 1 and Comparative Test Examples 1 and 2.

FIG. 7 is a graph illustrating the permeate concentration (μg/L) in Test Example 3 (total iodine CT value: 20 (mg/L·min)).

FIG. 8 is a graph illustrating the permeate concentration (μg/L) in Test Example 3 (total iodine CT value: 50 (mg/L·min)).

FIG. 9 is a graph illustrating the total chlorine concentration (mg/L as Cl₂) relative to the operating time (h) in Test Example 5.

FIG. 10 is a graph illustrating the total iodine removal rate (%) in Test Example 7 and Comparative Test Example 4.

FIG. 11 is a graph illustrating the sterilization effect in Test Example 8 and Comparative Test Examples 5 and 6.

### DESCRIPTION OF EMBODIMENTS

Embodiments of the present invention are described below. These embodiments are merely examples of implementing the present invention, and the present invention is not limited to these embodiments.

### <Water Treatment Device and Water Treatment Method Using Separation Membrane>

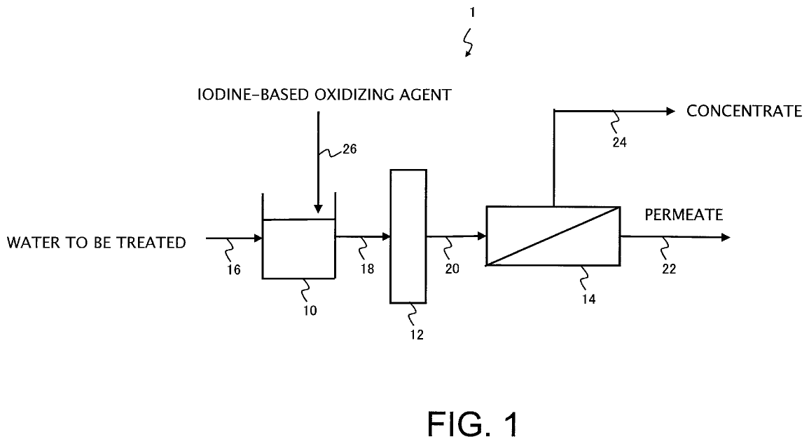

One example of a water treatment device according to an embodiment of the present invention is illustrated in FIG. 1, and the structure of that device is described below.

A water treatment device 1 illustrated in FIG. 1 contains a filtration treatment device 12 as a filtration treatment unit for subjecting the water to be treated to a filtration treatment using a separation membrane, and a reverse osmosis membrane treatment device 14 as a reverse osmosis membrane treatment unit for separating the filtration treated water into a permeate and a concentrate using a reverse osmosis membrane. The water treatment device 1 may also contain an water to be treated tank 10 for storing the water to be treated.

In the water treatment device 1, an water to be treated line 16 is connected to the inlet of the water to be treated tank 10. The outlet of the water to be treated tank 10 and the inlet of the filtration treatment device 12 are connected by a water to be treated supply line 18. The outlet of the filtration treatment device 12 and an inlet on the primary side of the reverse osmosis membrane treatment device 14 are connected by a filtration treated water line 20. A permeate line 22 is connected to a permeate outlet on the secondary side of the reverse osmosis membrane treatment device 14. A concentrate line 24 is connected to a concentrate outlet on the primary side of the reverse osmosis membrane treatment device 14. An iodine-based oxidizing agent addition line 26 is connected to the water to be treated tank 10 as an iodine-based oxidizing agent addition unit for adding an iodine-based oxidizing agent to the water to be treated.

In the water treatment device 1, the water to be treated passes through the water to be treated line 16 and, if necessary, is fed into the water to be treated tank 10 and stored. In the water to be treated tank 10, an iodine-based oxidizing agent is passed through the iodine-based oxidizing agent addition line 26 and added to the water to be treated, thereby introducing an iodine-based oxidizing agent (an iodine-based oxidizing agent addition step). The iodine-based oxidizing agent may be added at any stage prior to the filtration treatment device 12, and may be added to the water to be treated line 16, or added to the water to be treated supply line 18.

The water to be treated containing the added iodine-based oxidizing agent is fed through the water to be treated supply line 18 and into the filtration treatment device 12, and is subjected to a filtration treatment with a separation membrane in the filtration treatment device 12 to remove turbidity (a filtration treatment step). The filtration treated water that has undergone the filtration treatment is supplied to the reverse osmosis membrane treatment device 14 through the filtration treated water line 20, and is separated into a permeate and a concentrate by the reverse osmosis membrane in the reverse osmosis membrane treatment device 14 (a reverse osmosis membrane treatment step). The permeate obtained in the reverse osmosis membrane treatment is passed through the permeate line 22 and discharged. The concentrate obtained in the reverse osmosis membrane treatment is passed through the concentrate line 24 and discharged.

As a result of intensive investigation, the inventors of the present invention found that the iodine-based oxidizing agent permeates through the separation membrane, and discovered that by introducing an iodine-based oxidizing agent as an antibacterial agent into the water to be treated by the separation membrane, namely by adding the iodine-based oxidizing agent at a stage prior to the separation membrane, a water treatment using a separation membrane and a downstream reverse osmosis membrane could be conducted in which slime generation in both the separation membrane and the reverse osmosis membrane could be inhibited by a simple method. Accordingly, slime generation can be inhibited in both the separation membrane and the reverse osmosis membrane without having to provide multiple chemical injection devices.

Examples of the separation membrane include nanofiltration membranes (NF membranes), microfiltration membranes (MF membranes), ultrafiltration membranes (UF membranes), and forward osmosis membranes (FO membranes). Among these, in those cases where a microfiltration membrane (MF membrane) or ultrafiltration membrane (UF membrane) is used as the separation membrane, the water treatment device and water treatment method according to embodiments of the present invention can be applied particularly favorably.

Further, in those cases where polyamide-based polymer membranes such as polyamide-based reverse osmosis membranes, which are currently the most widely used type of membrane, are used as the separation membrane or the reverse osmosis membrane or the like, the water treatment device and water treatment method according to embodiments of the present invention can be applied particularly favorably. Polyamide-based reverse osmosis membranes and the like have comparatively low resistance to oxidizing agents, and if free chlorine or the like is kept in continuous contact with a polyamide-based reverse osmosis membrane or the like, then a marked deterioration in membrane performance tends to occur. However, in a water treatment method in which an iodine-based oxidizing agent is added to the water to be treated, this type of marked deterioration in membrane performance is less likely, even for polyamide-based reverse osmosis membranes and the like.

In the iodine-based oxidizing agent addition step, the total iodine CT value (mg/L·h) represented by (total iodine within the water to be treated (mg/L))×(iodine-based oxidizing agent addition time (h)) is preferably not more than 1.25 (mg/L·h), and more preferably 1.0 (mg/L·h) or less. Provided the total iodine CT value (mg/L·h) is not more than 1.25 (mg/L·h), permeation of the iodine-based oxidizing agent through the reverse osmosis membrane can be better inhibited, meaning any deterioration in the water quality of the permeate can be suppressed.

The membrane pore size of the separation membrane is preferably 0.01 μm or greater, and is more preferably at least 0.1 μm but not more than 100 μm. If the membrane pore size of the separation membrane is less than 0.01 μm, then the permeation rate of total iodine may sometimes decrease, whereas if the membrane pore size exceeds 100 μm, microparticles may sometimes not be completely removed, which may have an adverse effect on the reverse osmosis membrane.

The iodine-based oxidizing agent is an oxidizing agent that contains iodine. The “iodine” contained in the iodine-based oxidizing agent may be of any form, and may be one, or a combination, of molecular iodine, an iodide, a polyiodide, iodic acid, hypoiodous acid, hydrogen iodide, or iodine that is coordinated to an organic solvent such as polyvinylpyrrolidone or cyclodextrin. Further, the method used for obtaining any of these forms of iodine may employ a method in which solid iodine is dissolved in a non-polar solvent such as benzene or carbon tetrachloride or an alcohol, dissolved using an alkali agent and water, or dissolved using an iodide and water, or may yield total iodine by adding an acid or an oxidizing agent to a solvent containing at least one of an iodide and iodide ions. Furthermore, iodine that is coordinated to an organic solvent such as polyvinylpyrrolidone or cyclodextrin may be obtained using povidone-iodine which is composed of iodine coordinated to polyvinylpyrrolidone, cyclodextrin-iodine inclusion complex which is composed of an inclusion of iodine in cyclodextrin, or iodophors composed of iodine supported on an organic polymer or surfactant or the like. From the viewpoints of handling properties and water quality effects on the water to be treated and the treated water, the iodine-based oxidizing agent is preferably obtained by dissolving solid iodine using an iodide salt and water, without using any organic substances. The solubility of iodine in water is low, but dissolving solid iodine using an iodide salt and water yields a stable single liquid oxidizing agent of comparatively high concentration, which offers simple handling. The term “iodide” refers to iodine compounds with an oxidation number of 1, and examples include potassium iodide, sodium iodide, hydrogen iodide and silver iodide. Further, these iodides, of course, dissociate upon dissolution in water to form iodide ions. Examples of the iodide salt include inorganic iodide salts such as sodium iodide and potassium iodide, and the use of potassium iodide is preferred.

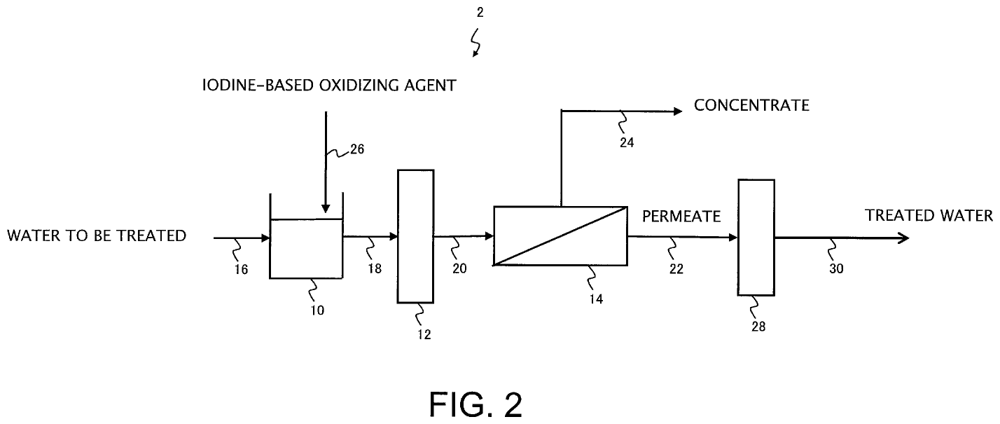

An iodine removal unit that removes iodine components from within the permeate may be provided downstream from the reverse osmosis membrane treatment device 14. An example of this type of structure is illustrated in FIG. 2.

A water treatment device 2 illustrated in FIG. 2 contains the filtration treatment device 12 as a filtration treatment unit for subjecting the water to be treated to a filtration treatment using a separation membrane, the reverse osmosis membrane treatment device 14 as a reverse osmosis membrane treatment unit for separating the filtration treated water into a permeate and a concentrate using a reverse osmosis membrane, and an iodine removal device 28 as an iodine removal unit for removing iodine components from within the permeate of the reverse osmosis membrane. The water treatment device 2 may also contain the water to be treated tank 10 for storing the water to be treated.

In the water treatment device 2, the water to be treated line 16 is connected to the inlet of the water to be treated tank 10. The outlet of the water to be treated tank 10 and the inlet of the filtration treatment device 12 are connected by the water to be treated supply line 18. The outlet of the filtration treatment device 12 and the inlet on the primary side of the reverse osmosis membrane treatment device 14 are connected by the filtration treated water line 20. The permeate outlet on the secondary side of the reverse osmosis membrane treatment device 14 and an inlet of the iodine removal device 28 are connected by the permeate line 22. The concentrate line 24 is connected to the concentrate outlet on the primary side of the reverse osmosis membrane treatment device 14. A treated water line 30 is connected to the outlet of the iodine removal device 28. The iodine-based oxidizing agent addition line 26 is connected to the water to be treated tank 10 as an iodine-based oxidizing agent addition unit for adding an iodine-based oxidizing agent to the water to be treated.

In the water treatment device 2, the water to be treated passes through the water to be treated line 16 and, if necessary, is fed into the water to be treated tank 10 and stored. In the water to be treated tank 10, an iodine-based oxidizing agent is passed through the iodine-based oxidizing agent addition line 26 and added to the water to be treated, thereby introducing an iodine-based oxidizing agent (an iodine-based oxidizing agent addition step). The iodine-based oxidizing agent may be added at any stage prior to the filtration treatment device 12, and may be added to the water to be treated line 16, or added to the water to be treated supply line 18.

The water to be treated containing the added iodine-based oxidizing agent is fed through the water to be treated supply line 18 and into the filtration treatment device 12, and is subjected to a filtration treatment with a separation membrane in the filtration treatment device 12 to remove turbidity (a filtration treatment step). The filtration treated water that has undergone the filtration treatment is supplied to the reverse osmosis membrane treatment device 14 through the filtration treated water line 20, and is separated into a permeate and a concentrate by the reverse osmosis membrane in the reverse osmosis membrane treatment device 14 (a reverse osmosis membrane treatment step). The permeate obtained in the reverse osmosis membrane treatment is passed through the permeate line 22 and fed into the iodine removal device 28, and following removal of the iodine components from within the permeate in the iodine removal device 28 (an iodine removal step), the permeate is passed through the treated water line 30 and discharged. The concentrate obtained in the reverse osmosis membrane treatment is passed through the concentrate line 24 and discharged.

As a result of intensive investigation, the inventors of the present invention discovered that, in a water treatment that uses a separation membrane and a downstream reverse osmosis membrane, in those cases where even if an iodine-based oxidizing agent is added to the water to be treated by the separation membrane, total iodine is not completely removed by the separation membrane and reverse osmosis membrane and is detected within the permeate of the reverse osmosis membrane, by providing an iodine removal device on the secondary side of the reverse osmosis membrane, the effects of total iodine permeating through to downstream from the reverse osmosis membrane can be reduced. In those cases where a water usage system is also provided downstream from the water treatment device 2, the effects on that water usage system can also be suppressed.

One or more of reducing agent addition, activated carbon, an anion exchanger, a scrubber and a degassing membrane may be used as the iodine removal device, and the use of activated carbon or an anion exchanger is preferred. Either an activated carbon filtration device or an activated carbon filter may be used as the activated carbon, and an activated carbon filter is preferred. Either a weak anion exchange resin or a strong anion exchange resin may be used as the anion exchanger, and a strong anion exchange resin is preferred.

In a water treatment that uses a separation membrane and a downstream reverse osmosis membrane, in those cases where an iodine-based oxidizing agent is added to the water to be treated by the separation membrane, because the molecular weight of iodine is large (the molecular weight of the I₂ molecule is 253.8), it was thought that by using a membrane that exhibits superior removal performance for salts, such as a nanofiltration membrane or reverse osmosis membrane, iodine could also be satisfactorily removed. However, the inventors of the present invention discovered that even with a membrane such as a nanofiltration membrane or reverse osmosis membrane, iodine is not completely removed, with total iodine being detected in the permeate of the reverse osmosis membrane, and it became clear that by providing an additional iodine removal device in the treated water line from the reverse osmosis membrane, the effects of total iodine on the treated water downstream from the reverse osmosis membrane could be reduced.

It is already known that iodine is used in the evaluation of the adsorption performance of activated carbon, and that activated carbon may be used in the removal of radioactive iodine, but activated carbon is not normally provided in the permeate line from a reverse osmosis membrane, and unless it was clear that total iodine had permeated through the reverse osmosis membrane, activated carbon has conventionally not been used. Further, in a similar manner to activated carbon, the provision of an anion exchanger in the permeate line from a reverse osmosis membrane for the purpose of removing total iodine that has permeated through the membrane has not previously been reported.

The method used for adding the iodine-based oxidizing agent to the water to be treated may involve continuous addition in which the iodine-based oxidizing agent is added continuously, or intermittent addition which provides an addition period during which the iodine-based oxidizing agent is added to the water to be treated and a non-addition period during which the iodine-based oxidizing agent is not added to the water to be treated. In other words, in the case of intermittent addition, the method includes a step of adding the iodine-based oxidizing agent to the water to be treated and supplying the water to be treated to the filtration treatment device 12, and a step of supplying the water to be treated to the filtration treatment device 12 without adding the iodine-based oxidizing agent to the water to be treated. The sterilizing power of iodine-based oxidizing agents is extremely high, and because a sterilization effect can be achieved in an extremely short period of time, adding the iodine-based oxidizing agent intermittently to the water to be treated yields a satisfactory slime inhibitory effect on the separation membrane and the reverse osmosis membrane.

In the case of intermittent addition, for example, the addition period is a continuous period at least 10 seconds but not longer than 3 hours, and the non-addition period is a continuous period of at least 5 seconds but less than 1,440 minutes. In the case of intermittent addition, it is preferable that the addition period is a continuous period at least 10 seconds but not longer than 10 minutes, and the non-addition period is a continuous period of at least 1 minute but less than 1,440 minutes. If the addition period is too long, there is a possibility of adverse effects on the membrane, whereas if the non-addition period is too long, there is a possibility that this may cause a marked proliferation in the microbes that cause slime.

The level of total iodine and the overall iodine atom permeation rate achieved as a result of addition of the iodine-based oxidizing agent tend to rise gradually after addition of the iodine-based oxidizing agent to the separation membrane and the reverse osmosis membrane, and therefore by conducting intermittent addition with a short addition period, the level of permeated total iodine and the total amount of iodine atoms can be satisfactorily suppressed.

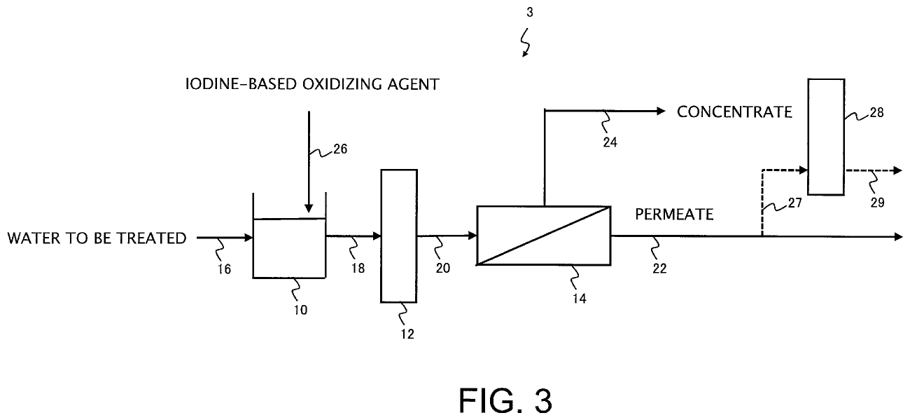

By providing an addition period and a non-addition period, and passing the water through the iodine removal device only in those periods where total iodine is detected in the permeate from the reverse osmosis membrane, the load on the iodine removal device can be reduced, and a water treatment method can be adopted in which the permeate is discharged outside the system during those periods when total iodine is detected in the permeate during the addition period. An example of a water treatment device with this type of structure is illustrated in FIG. 3.

In a water treatment device 3 illustrated in FIG. 3, the water to be treated line 16 is connected to the inlet of the water to be treated tank 10. The outlet of the water to be treated tank 10 and the inlet of the filtration treatment device 12 are connected by the water to be treated supply line 18. The outlet of the filtration treatment device 12 and the inlet on the primary side of the reverse osmosis membrane treatment device 14 are connected by the filtration treated water line 20. The permeate line 22 is connected to the permeate outlet on the secondary side of the reverse osmosis membrane treatment device 14, whereas the concentrate line 24 is connected to the concentrate outlet on the primary side. A line 27 that branches from the permeate line 22 is connected to the inlet of the iodine removal device 28, and a line 29 is connected to the outlet of the iodine removal device 28. The iodine-based oxidizing agent addition line 26 is connected to the water to be treated tank 10 as an iodine-based oxidizing agent addition unit for adding an iodine-based oxidizing agent to the water to be treated.

In the water treatment device 3, the water to be treated passes through the water to be treated line 16 and, if necessary, is fed into the water to be treated tank 10 and stored. In the non-addition period during which the iodine-based oxidizing agent is not added to the water to be treated, the water to be treated is fed into the filtration treatment device 12 through the water to be treated supply line 18, and is subjected to a filtration treatment with a separation membrane in the filtration treatment device 12 to remove turbidity (a filtration treatment step). The filtration treated water that has undergone the filtration treatment is supplied to the reverse osmosis membrane treatment device 14 through the filtration treated water line 20, and is separated into a permeate and a concentrate by the reverse osmosis membrane in the reverse osmosis membrane treatment device 14 (a reverse osmosis membrane treatment step). The permeate obtained in the reverse osmosis membrane treatment is passed through the permeate line 22 and discharged, and the concentrate is passed through the concentrate line 24 and discharged.

On the other hand, in the addition period during which the iodine-based oxidizing agent is added to the water to be treated, the iodine-based oxidizing agent is added to the water to be treated in the water to be treated tank 10 through the iodine-based oxidizing agent addition line 26, thereby introducing an iodine-based oxidizing agent (an iodine-based oxidizing agent addition step). The iodine-based oxidizing agent may also be added to the water to be treated line 16, or added to the water to be treated supply line 18.

The water to be treated containing the added iodine-based oxidizing agent is fed into the filtration treatment device 12 through the water to be treated supply line 18, and is subjected to a filtration treatment with a separation membrane in the filtration treatment device 12 to remove turbidity (a filtration treatment step). The filtration treated water that has undergone the filtration treatment is supplied to the reverse osmosis membrane treatment device 14 through the filtration treated water line 20, and is separated into a permeate and a concentrate by the reverse osmosis membrane in the reverse osmosis membrane treatment device 14 (a reverse osmosis membrane treatment step). The permeate containing total iodine obtained in the reverse osmosis membrane treatment is passed through the permeate line 22 and the line 27 and fed into the iodine removal device 28, and following removal of the iodine components within the permeate in the iodine removal device 28 (an iodine removal step), is passed through the line 29 and discharged. The concentrate obtained in the reverse osmosis membrane treatment is passed through the concentrate line 24 and discharged.

In this manner, because a sterilization effect can be achieved in an extremely short period of time, and the permeation of total iodine can also be inhibited, when the iodine-based oxidizing agent is added to the water to be treated by the separation membrane, intermittent addition can be said to be an iodine addition method that yields satisfactory performance, a favorable cost reduction, and a reduction in adverse effects on the water quality.

The addition period and the non-addition period are preferably counted only when the flow rate of the water to be treated is measured, and that flow rate of the water to be treated is at least as high as a prescribed value. This suppresses ineffective chemical consumption such as the injection of chemicals during sudden device stoppages caused by trouble or the like.

In this description, the oxidizing power of all the oxidizing agents is represented by the total chlorine value determined using the DPD method. In this description, the term “total chlorine” refers to a concentration determined by absorption spectrophotometry using N,N-diethyl-p-phenylenediammonium sulfate (DPD) as disclosed in section 33 “Residual Chlorine” in JIS K 0120:2013. In one example, 2.5 mL of a 0.2 mol/L potassium dihydrogen phosphate solution is placed in a 50 mL colorimetric tube, 0.5 g of a dilute powder of DPD (prepared by crushing 1.0 g of N,N-diethyl-p-phenylenediammonium sulfate and then mixing the powder with 24 g of sodium sulfate) is added, 0.5 g of potassium iodide is added, an appropriate amount of the sample is added, water is then added to bring the volume up to the marked line and dissolve the mixture, and the resulting solution is left to stand for about three minutes. The absorbance of the resulting pink to pinky red color is measured near a wavelength of 510 nm (or 555 nm) and used to quantify the oxidizing agents. DPD is oxidized by all manner of oxidizing agents, and examples of oxidizing agents that can be measured include chlorine, bromine, iodine, hydrogen peroxide, and ozone and the like. In the case of the iodine-based oxidizing agent used in embodiments of the present invention, all the iodine forms that have oxidizing power (for example, I₂, IO₃⁻, IO⁻, HI) can be jointly measured as “total chlorine”. Further, “total chlorine” may be converted to “total iodine”. Specifically, a conversion may be made based on the “molecular weight of chlorine” and the “molecular weight of iodine”. In other words, “total chlorine”×(126.9/35.45)≈“total chlorine”×3.58=“total iodine”.

By maintaining the total residual chlorine concentration within the concentrate from the reverse osmosis membrane at a value of 0.05 mg/L or higher, an effective slime inhibitory effect can be achieved. The “total residual chlorine concentration within the concentrate” indicates the “total chlorine concentration detected following a residence time, following commencement of the addition of the iodine-based oxidizing agent, from the iodine-based oxidizing agent addition location until the obtaining of the concentrate of the reverse osmosis membrane”. By using this concentration detected with due consideration of the residence time, following commencement of the addition of the iodine-based oxidizing agent, from the iodine-based oxidizing agent addition location until the obtaining of the concentrate of the reverse osmosis membrane as the total residual chlorine concentration within the concentrate, more accurate operational control can be achieved.

From the viewpoint of suppression or the like of biofouling, the total residual chlorine concentration within the concentrate from the reverse osmosis membrane is preferably at least 0.1 mg/L, and is more preferably 0.2 mg/L or greater. Particularly in the case of intermittent addition when an addition period and a non-addition period are provided, it is thought that proliferation of microbes and the like during the non-addition period causes considerable consumption of the active component from the addition period, meaning control of the total residual chlorine concentration within the concentrate from the reverse osmosis membrane is even more important.

In those cases where the iodine-based oxidizing agent is an oxidizing agent obtained by dissolving iodine using an iodide salt such as potassium iodide, namely an oxidizing agent that contains iodine and iodide, from the viewpoint of factors such as the cost of the added chemicals and the permeation of iodine through the reverse osmosis membrane, the molar ratio of iodide (at least one of an iodide salt and iodide ions) relative to iodine (namely, iodide (at least one of an iodide salt and iodide ions)/iodine) is preferably within a range from 1 to 1.9, from the viewpoints of the amount of permeation relative to the total iodine CT value added to the water to be treated (total iodine atom concentration×addition time) and the total iodine yield, is more preferably within a range from 1.5 to 1.9, and is even more preferably within a range from 1.8 to 1.9. The term “total iodine atoms” means the total amount of iodine present in any form, regardless of whether or not that form exhibits oxidizing power. Examples of these forms of iodine include I₂, IO₃⁻, IO⁻, HI, I⁻ and I₃⁻. The total iodine atoms can be measured using ICP-MS.

Iodine can be dissolved in water or the like by using an iodide salt, but iodide salts are more expensive than iodine, and the higher the molar ratio of iodide to iodine becomes, the more the chemical costs increase, and therefore the molar ratio of iodide relative to iodine is preferably kept low. Further, in terms of the amount of permeation relative to the total iodine CT value added to the separation membrane, because the amount of permeation is less when the molar ratio of iodide relative to iodine is lower, the molar ratio of iodide relative to iodine is preferably low. On the other hand, if the molar ratio of iodide relative to iodine is too low, then the total iodine yield (total amount of iodine relative to the mixed iodine) becomes too low, and therefore the molar ratio is preferably maintained at a certain prescribed value or higher.

The pH of the water to be treated is preferably within a range from 2 to 12, and more preferably within a range from 4 to 9. If the pH of the water to be treated exceeds 9, then the slime inhibitory effect tends to deteriorate due to a reduction in the amount of the active component, and if the pH exceeds 12, then a satisfactory slime inhibitory effect may sometimes be unattainable, whereas if the pH is less than 2, then crystals of iodine may sometimes precipitate, and a satisfactory slime inhibitory effect may sometimes be unattainable.

There are no particular limitations on the type of membrane used or the operating pressure for the reverse osmosis membrane in the water treatment device and water treatment method according to embodiments of the present invention, and operation may be conducted at any pressure that yields a permeate from the reverse osmosis membrane. For example, a salt water reverse osmosis membrane (low pressure reverse osmosis membrane) may be operated at 0.2 to 1.2 MPa, a seawater desalination reverse osmosis membrane (high pressure reverse osmosis membrane) may be operated at 3 to 5.5 MPa, and a seawater desalination reverse osmosis membrane (high pressure reverse osmosis membrane) may be operated for a salt water application at a pressure of 1.5 to 3.5 MPa.

In those cases where the reverse osmosis membrane is a polyamide-based reverse osmosis membrane, the chlorine content of the membrane surface of the reverse osmosis membrane is preferably at least 0.1 atom %, and is more preferably 0.5 atom % or greater. If the chlorine content of the membrane surface of the reverse osmosis membrane is less than 0.1 atom %, then the permeate volume may sometimes decrease. The chlorine content of the reverse osmosis membrane surface can be measured by X-ray photoelectron spectroscopy.

The water to be treated by the filtration treatment device 12 in the water treatment method and water treatment device according to embodiments of the present invention may be a water to be treated that contains organic matter, or may be a water to be treated that contains organic matter and nitrogen compounds. An example of a water to be treated containing organic matter is the treated water obtained from a wastewater treatment unit. The wastewater treatment unit may use any of biological treatment, coagulation and settling, pressure flotation, sand filtration or biological activated carbon, or may use a combination of these techniques. The water to be treated may also be a biologically treated water obtained from a biological treatment unit (a biological treatment step).

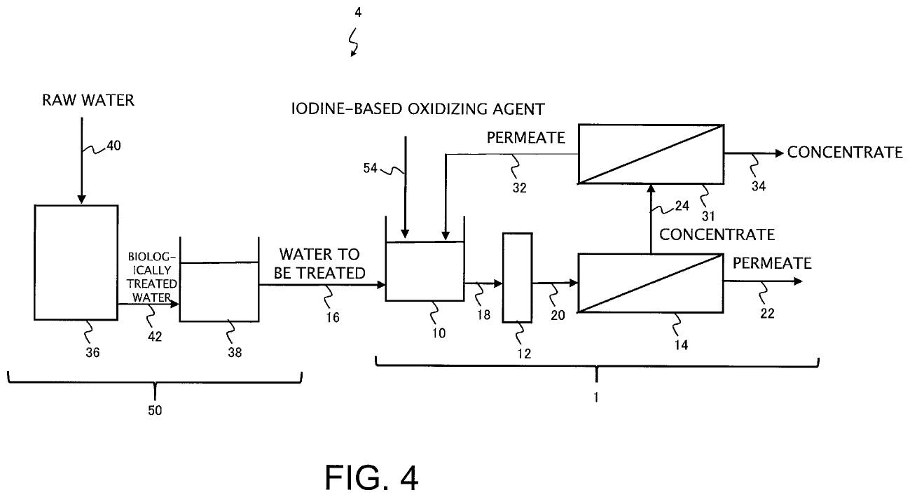

It is thought that the water treatment method and water treatment device according to embodiments of the present invention will be particularly suited to application to wastewater recovery, such as the recovery of wastewater from the electronics industry, food production wastewater, beverage production wastewater, chemical plant wastewater, and plating plant wastewater and the like. In particular, water recovered from wastewater from the electronics industry often contains ammonia, and one example of a possible wastewater recovery flow in such a case is the type of flow illustrated in FIG. 4, having the water treatment device 1, which contains the filtration treatment device 12 and the reverse osmosis membrane treatment device 14 that utilize the water treatment device and water treatment method according to embodiments of the present invention, located downstream from a biological treatment system 50 containing a biological treatment device 36.

The water treatment system 4 illustrated in FIG. 4 contains, for example, the biological treatment device 36 as a biological treatment unit, a biologically treated water tank 38, and the water treatment device 1. The water treatment system 4 may also contain a second reverse osmosis membrane treatment device 31 as a second reverse osmosis membrane treatment unit.

In the water treatment system 4, a raw water line 40 is connected to the inlet of the biological treatment device 36. The outlet of the biological treatment device 36 and the inlet of the biologically treated water tank 38 are connected by a biologically treated water line 42. The outlet of the biologically treated water tank 38 and the inlet of the water to be treated tank 10 are connected by the water to be treated line 16. The outlet of the water to be treated tank 10 and the inlet of the filtration treatment device 12 are connected by the water to be treated supply line 18. The outlet of the filtration treatment device 12 and an inlet on the primary side of the reverse osmosis membrane treatment device 14 are connected by the filtration treated water line 20. The permeate line 22 is connected to the permeate outlet on the secondary side of the reverse osmosis membrane treatment device 14. The concentrate outlet on the primary side of the reverse osmosis membrane treatment device 14 and an inlet on the primary side of the second reverse osmosis membrane treatment device 31 are connected by the concentrate line 24. A concentrate line 34 is connected to a concentrate outlet on the primary side of the second reverse osmosis membrane treatment device 31, and a permeate outlet on the secondary side of the second reverse osmosis membrane treatment device 31 and a permeate inlet of the water to be treated tank 10 are connected by a permeate line 32. An iodine-based oxidizing agent addition line 54 is connected to the water to be treated tank 10 as an iodine-based oxidizing agent addition unit for adding an iodine-based oxidizing agent to the water to be treated.

In the water treatment system 4, a raw water such as a wastewater from the electronics industry is passed through the raw water line 40 and fed into the biological treatment device 36, and a biological treatment is conducted in the biological treatment device 36 (a biological treatment step). The biologically treated water that has undergone this biological treatment is passed through the biologically treated water line 42 and, is stored in the biologically treated water tank 38 if necessary, and is then passed through the water to be treated line 16 as a water to be treated and, if necessary, is fed into the water to be treated tank 10 of the water treatment device 1 and stored. For example, an iodine-based oxidizing agent is passed through the iodine-based oxidizing agent addition line 54 and added to the water to be treated in the water to be treated tank 10, thereby introducing an iodine-based oxidizing agent (an iodine-based oxidizing agent addition step). The iodine-based oxidizing agent may also be added to the biologically treated water line 42, added to the biologically treated water tank 38, added to the water to be treated line 16, or added to the water to be treated supply line 18.

The water to be treated containing the added iodine-based oxidizing agent is fed through the water to be treated supply line 18 and into the filtration treatment device 12, and is subjected to a filtration treatment with a separation membrane in the filtration treatment device 12 to remove turbidity (a filtration treatment step). The filtration treated water that has undergone the filtration treatment is supplied to the reverse osmosis membrane treatment device 14 through the filtration treated water line 20, and is separated into a permeate and a concentrate by the reverse osmosis membrane in the reverse osmosis membrane treatment device 14 (a reverse osmosis membrane treatment step). The permeate obtained in the reverse osmosis membrane treatment is passed through the permeate line 22 and discharged. The concentrate obtained in the reverse osmosis membrane treatment is passed through the concentrate line 24 and discharged. If necessary, the concentrate obtained in the reverse osmosis membrane treatment may be fed into the second reverse osmosis membrane treatment device 31, and an additional reverse osmosis membrane treatment may be conducted in the second reverse osmosis membrane treatment device 31 (a second reverse osmosis membrane treatment). The concentrate obtained in the second reverse osmosis membrane treatment is passed through the concentrate line 34 and discharged outside the system. The permeate obtained in the second reverse osmosis membrane treatment may be discharged outside the system, or if necessary, may be passed through the permeate line 32 and recirculated into the water to be treated tank 10.

In the water treatment system 4 illustrated in FIG. 4, the biological treatment system 50 having a separate biological treatment device 36 and biologically treated water tank 38 is shown as an example, but a membrane separation activated sludge device (MBR) which combines these devices into a single unit may also be used.

In a wastewater recovery flow such as the water treatment system 4, the second reverse osmosis membrane treatment device 31 (brine reverse osmosis membrane) is typically provided to increase the water recovery rate. The second reverse osmosis membrane treatment device 31 utilizes the concentrate from the reverse osmosis membrane treatment device 14 as the water to be treated, and then, for example, returns the resulting permeate to the water to be treated tank 10 and discharges the concentrate outside the system.

In the water treatment system 4 illustrated in FIG. 4, a biological treatment was described as an example of a pretreatment to the reverse osmosis membrane treatment, but this pretreatment step prior to the reverse osmosis membrane treatment may, if necessary, involve conducting a biological, physical or chemical pretreatment such as a biological treatment, coagulation treatment, coagulation and settling treatment, pressure flotation treatment, filtration treatment, membrane separation treatment, activated carbon treatment, ozone treatment or ultraviolet irradiation treatment, or a combination of two or more of these pretreatments.

In the water treatment system 4, in addition to the reverse osmosis membrane, if necessary, the system may also contain a pump, safety filter, flow rate measurement device, pressure measurement device, temperature measurement device, oxidation-reduction potential (ORP) measurement device, residual chlorine measurement device, electrical conductivity measurement device, pH measurement device, and/or energy recovery device or the like.

In the water treatment system 4, if necessary, a scale inhibitor other than the iodine-based oxidizing agent or a pH modifier may be added to at least one of the biologically treated water or the water to be treated in at least one of the biologically treated water tank 38 or the lines upstream and downstream thereof, and the water to be treated tank 10 or the lines upstream and downstream thereof.

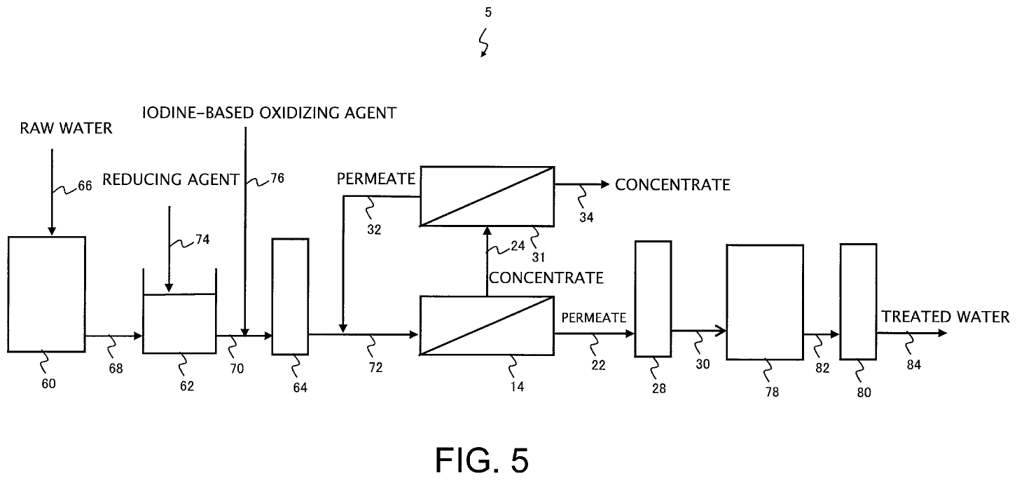

The water treatment device and water treatment method of embodiments of the present invention may potentially be applied, for example, to pure water production. For example, one possible flow includes the iodine removal device 28 as an iodine removal unit downstream from the pure water production, as illustrated in FIG. 5.

The water treatment system 5 illustrated in FIG. 5 contains, for example, a sand filtration device 60 as a filtration treatment unit, a filtered water tank 62, a filtration treatment device 64 as a filtration treatment unit, an ion removal device 78 such as an ion exchange treatment device or an electrodeionization treatment device (EDI) as an ion removal unit, and a membrane filtration device 80 having an ultrafiltration membrane (UF membrane) as a membrane filtration unit. The water treatment system 5 may also contain the second reverse osmosis membrane treatment device 31 as a second reverse osmosis membrane treatment unit.

In the water treatment system 5, a raw water line 66 is connected to the inlet of the sand filtration device 60. The outlet of the sand filtration device 60 and the inlet of the filtered water tank 62 are connected by a filtered water line 68. The outlet of the filtered water tank 62 and the inlet of the filtration treatment device 64 are connected by a filtered water supply line 70. The outlet of the filtration treatment device 64 and the inlet on the primary side of the reverse osmosis membrane treatment device 14 are connected by a filtration treated water line 72. The permeate outlet on the secondary side of the reverse osmosis membrane treatment device 14 and the inlet of the iodine removal device 28 are connected by the permeate line 22. The outlet of the iodine removal device 28 and the inlet of the ion removal device 78 are connected by the treated water line 30. The outlet of the ion removal device 78 and the inlet of the membrane filtration device 80 are connected by an ion removal treated water line 82. A treated water line 84 is connected to the outlet of the membrane filtration device 80. The concentrate outlet on the primary side of the reverse osmosis membrane treatment device 14 and the inlet on the primary side of the second reverse osmosis membrane treatment device 31 are connected by the concentrate line 24. The concentrate line 34 is connected to the concentrate outlet on the primary side of the second reverse osmosis membrane treatment device 31, and the permeate outlet on the secondary side of the second reverse osmosis membrane treatment device 31 and the filtration treated water line 72 are connected by the permeate line 32. A reducing agent addition line 74 is connected to the filtered water tank 62 as a reducing agent addition unit. An iodine-based oxidizing agent addition line 76 is connected to the filtered water supply line 70 as an iodine-based oxidizing agent addition unit for adding the iodine-based oxidizing agent to the water to be treated.

In the water treatment system 5, the raw water is passed through the raw water line 66 and fed into the sand filtration device 60, and a filtration treatment is conducted in the sand filtration device 60 (a filtration step). The filtered water that has undergone the filtration treatment is stored in the filtered water tank 62, and following supply of a reducing agent through the reducing agent addition line 74 to the filtered water tank 62, the filtered water is fed into the filtration treatment device 64, and is subjected to a filtration treatment with a separation membrane in the filtration treatment device 64 to remove turbidity (a filtration treatment step). The filtration treated water that has undergone the filtration treatment is supplied to the reverse osmosis membrane treatment device 14 through the filtration treated water line 72. In the filtered water supply line 70, for example, an iodine-based oxidizing agent is added to the water to be treated through the iodine-based oxidizing agent addition line 76, thereby introducing an iodine-based oxidizing agent (an iodine-based oxidizing agent addition step).

The filtration treated water that has undergone the filtration treatment is separated into a permeate and a concentrate by the reverse osmosis membrane in the reverse osmosis membrane treatment device 14 (a reverse osmosis membrane treatment step). The permeate obtained in the reverse osmosis membrane treatment is passed through the permeate line 22 and fed into the iodine removal device 28, and following removal of the iodine components from within the permeate in the iodine removal device 28 (an iodine removal step), the permeate is passed through the treated water line 30 and fed into the ion removal device 78, and an ion removal treatment is conducted in the ion removal device 78 (an ion removal treatment step). The ion removal treated water that has undergone the ion removal treatment is fed into the membrane filtration device 80 through the ion removal treated water line 82, and a membrane filtration treatment is conducted in the membrane filtration device 80 (a membrane filtration treatment step). The membrane filtration treated water that has undergone the membrane filtration treatment is passed through the treated water line 84 and discharged. If necessary, the concentrate obtained in the reverse osmosis membrane treatment may be fed into the second reverse osmosis membrane treatment device 31, and an additional reverse osmosis membrane treatment may be conducted in the second reverse osmosis membrane treatment device 31 (a second reverse osmosis membrane treatment step). The concentrate obtained in the second reverse osmosis membrane treatment is passed through the concentrate line 34 and discharged outside the system. The permeate obtained in the second reverse osmosis membrane treatment may be discharged outside the system, or if necessary, may be passed through the permeate line 32 and recirculated into the filtration treated water line 72.

### <Slime Inhibitor for Membranes>

A slime inhibitor for membranes according to an embodiment of the present invention contains water, iodine and an iodide. The slime inhibitor for membranes according to an embodiment of the present invention may be used, for example, as a slime inhibitor in a water treatment that uses a separation membrane and a downstream reverse osmosis membrane in accordance with the water treatment device and water treatment method described above.

The slime inhibitor for membranes contains water, iodine and an iodide, and the molar ratio of the iodide to iodine, as mentioned above, is preferably within a range from 1 to 1.9. From the viewpoints of stability and the like, this slime inhibitor has a pH that is preferably at least 3 but not more than 9, more preferably at least 3 but not more than 7, and even more preferably at least 4 but not more than 6.5. If the pH is less than 3, then there is a possibility that crystals of iodine may precipitate, whereas if the pH exceeds 9, then there is a possibility that the amount of the active component may decrease markedly. Further, if consideration is given to transport costs and the like for the slime inhibitor, then the slime inhibitor preferably exhibits superior stability at high concentration, and the total iodine concentration is preferably at least 3% by mass, more preferably within a range from at least 3% by mass to not more than 40% by mass, and even more preferably within a range from at least 10% by mass to not more than 25% by mass.

### EXAMPLES

The present invention is described below more specifically and in further detail using a series of examples and comparative examples, but the present invention is in no way limited by the following examples.

### Example 1

### [Permeation Test, Sterilization Effect Test]

The methods described below were used to confirm that an iodine-based oxidizing agent (water+iodine+potassium iodide) permeated through and could sterilize precision filtration membranes used as turbidity removal membranes.

### (Test Conditions)

Test water: Sagamihara well water (dechlorinated, bacterial count: 2×10³ CFU/mL)
Reagent: Iodine-based oxidizing agent (3)
Turbidity removal membranes pore size: 0.01 μm (polyvinylidene fluoride (PVDF)), 0.02 μm (PVDF), 0.05 μm (PVDF), 0.1 μm (polysulfone), 0.2 μm (polysulfone), 1.0 μm (polypropylene), 10 μm (polypropylene)
Test water pH: 7.0

### (Iodine-Based Oxidizing Agent (3))

This oxidizing agent was prepared by mixing iodine, potassium iodide and water in the formulation (% by mass) shown in Table 1. The pH, total iodine (% by mass) and total iodine yield for the composition were as shown in Table 1. The total chlorine concentration was measured using a multi-item water quality analyzer DR/3900 manufactured by Hach Company, and the result was converted to total iodine.

Specifically, potassium iodide was dissolved in water under stirring, and once a substantially uniform solution had been obtained, iodine was added and the resulting mixture was stirred for about 30 minutes to prepare a substantially uniform iodine-based oxidizing agent (3).

TABLE 1

| | | Iodine-based oxidizing agent | | | | | | | | | | | |
|---|---|---|---|---|---|---|---|---|---|---|---|---|---|
| | | (1) | (2) | (3) | (4) | (5) | (6) | (7) | (8) | (9) | (10) | (11) | (12) |
| Formulation | Water | 69.8 | 64.8 | 63.9 | 63 | 62 | 60.9 | 60 | 58.2 | 56.5 | 54.6 | 52.2 | 49.5 |
| [% by mass] | Iodine | 10.2 | 15.2 | 16.1 | 17 | 18 | 19.1 | 20 | 21.8 | 23.5 | 25.4 | 27.8 | 30.5 |
| | KI | 20 | 20 | 20 | 20 | 20 | 20 | 20 | 20 | 20 | 20 | 20 | 20 |
| Physical | pH | 6.06 | 5.66 | 6.25 | 6.25 | 6.24 | 6.20 | 5.57 | 4.19 | 4.12 | 4.05 | 3.84 | 3.84 |
| properties | Total iodine | 10.2 | 15.2 | 16.1 | 17 | 17 | 17.8 | 18.4 | 19.9 | 21.2 | 22.9 | 19.5 | 20.9 |
| | [% by mass] | | | | | | | | | | | | |
| | Total iodine yield | 100 | 100 | 100 | 100 | 94 | 93 | 92 | 91 | 90 | 90 | 70 | 69 |
| | [%] | | | | | | | | | | | | |
| | [KI]/[I₂] | 3 | 2 | 1.9 | 1.8 | 1.7 | 1.6 | 1.5 | 1.4 | 1.3 | 1.2 | 1.1 | 1.0 |
| | [mol]/[mol] | | | | | | | | | | | | |

| | | | |
|---|---|---|---|
| Storage | Room | 30 days | 100 |
| stability | temp. | 60 days | 99 |
| [%] | | 90 days | 99 |
| | 50° C. | 30 days | 99 |
| | | 60 days | 99 |
| | | 90 days | 99 |

The iodine-based oxidizing agent was added to the water to be treated, and the resulting water was treated with a turbidity removal membrane. The permeation rate (%) of total iodine 5 minutes after commencing the addition is shown in Table 2. Further, the bacterial count of the test water was measured prior to addition of the reagent, and the bacterial count of the filtration treated water following addition of the reagent was also measured to confirm the sterilization effect of the reagent. The bacterial count was measured using a Sheet Check R2A (manufactured by Nipro Corporation).

TABLE 2

| | Membrane | Total iodine concentration | Addition | Total iodine | Bacterial count |
|---|---|---|---|---|---|
| | pore size | in water to be treated | time | permeation rate | in permeate |
| | (μm) | (mg/L) | (minutes) | (%) | (CFU/mL) |
| Example 1-1 | 0.01 | 1.8 | 5 | 88.7 | <10 |
| Example 1-2 | 0.02 | 1.8 | 5 | 90.0 | <10 |
| Example 1-3 | 0.05 | 1.8 | 5 | 98.0 | <10 |
| Example 1-4 | 0.1 | 1.8 | 5 | 96.1 | <10 |
| Example 1-5 | 0.2 | 1.8 | 5 | 98.2 | <10 |
| Example 1-6 | 1.0 | 1.8 | 5 | 98.3 | <10 |
| Example 1-7 | 10 | 1.8 | 5 | 98.1 | <10 |

With the total iodine concentration in the water to be treated by the turbidity removal membrane set to 1.8 mg/L, the iodine-based oxidizing agent was added for 5 minutes, and the result of measuring the total iodine concentration in the permeate revealed a total iodine permeation rate of at least 88% in each case. In each example, the bacterial count in the permeate decreased to <10. The total iodine CT value in Examples 1-1 to 1-7 was 0.15 mg/L·h. Further, adding the iodine-based oxidizing agent for a further 5 minutes (for a total of 10 minutes of water flow, total iodine CT value: 0.3 mg/L·h) resulted in a total iodine permeation rate of at least 96% in each example.

### Example 2, Reference Example 1

### [Investigation of Total Iodine CT Value]

Using the water treatment device illustrated in FIG. 1, treatment was conducted with various values for the total iodine CT value (mg/L·h) represented by (total iodine within the water to be treated (mg/L))×(iodine-based oxidizing agent addition time (h)). The results are shown in Table 3.

### (Test Conditions)

Test water: Sagamihara well water (dechlorinated, bacterial count: 2×10³ CFU/mL)

Reagent: Iodine-based oxidizing agent (3)

pH: 7.0

Reverse osmosis membranes: ES20, ESPA2, LFC3, TML10D

TABLE 3

| | | Total iodine | | |
|---|---|---|---|---|
| | Total | concentration | | Total iodine |
| | iodine | C in water | Addition | concentration |
| | CT value | to be treated | time T | in permeate |
| | (mg/L · h) | (mg/L) | (h) | (mg/L) |
| Reference | 2.5 | 5 | 0.5 | 1.1 |
| Example 1-1 | | | | |
| Reference | 4 | 2 | 2 | 1.3 |
| Example 1-2 | | | | |
| Reference | 7.5 | 15 | 0.5 | 4.5 |
| Example 1-3 | | | | |
| Example 2-1 | 0.43 | 5.4 | 0.08 | 0.03 |
| Example 2-2 | 0.46 | 2.7 | 0.17 | |
| Example 2-3 | 0.45 | 0.9 | 0.5 | |
| Example 2-4 | 0.50 | 0.25 | 2 | |
| Example 2-5 | 0.68 | 2.7 | 0.25 | 0.1 |
| Example 2-6 | 0.70 | 5.4 | 0.13 | |
| Example 2-7 | 0.75 | 0.9 | 0.83 | |
| Example 2-8 | 0.75 | 0.25 | 3 | |
| Example 2-9 | 0.90 | 5.3 | 0.17 | 0.14 |
| Example 2-10 | 0.89 | 2.7 | 0.33 | |
| Example 2-11 | 0.90 | 0.9 | 1 | |
| Example 2-12 | 1.0 | 0.25 | 4 | |
| Example 2-13 | 1.1 | 0.9 | 1.2 | 0.18 |
| Example 2-14 | 1.1 | 2.7 | 0.42 | |
| Example 2-15 | 1.2 | 5.4 | 0.22 | |
| Example 2-16 | 1.25 | 0.25 | 5 | |

For each of the total iodine concentration values in the water to be treated, the bacterial count in the permeate decreased to <10. Slime generation was able to be inhibited in both the separation membrane and the reverse osmosis membrane by a simple method. In Reference Example 1, as a result of conducting water flow at a high CT value, a high total iodine concentration was detected in the permeate. In the examples, the total iodine concentration in the permeate was able to be suppressed. It is thought that the difference in total iodine permeation rate caused by the difference in CT value of the reverse osmosis membrane was due to the level of iodine adsorption and the high molecular weight of the membrane. It is known that iodine exhibits a high level of adsorption and adsorbs particularly favorably to polymer substances, and it is thought that iodine adsorbs to polymer membranes via a similar mechanism, with the amount of permeation changing in accordance with the amount of adsorption, and the fact that the amount of adsorption is determined by the total iodine concentration in the water to be treated and the addition time was clearly established by the inventors of the present invention. Moreover, it has been confirmed that during a removal process using a strong anion exchange resin described below, uncharged iodine can be effectively removed, and it is thought that this adsorption mechanism functions particularly effectively with a polyamide-based polymer. When the adsorbed iodine exceeds a certain CT value, the iodine starts to be detected on the permeate side, but by stopping addition of the reagent at value less than that CT value, and introducing a non-addition period, the iodine can be discharged to the concentrate side during the non-addition period.

### [Slime Inhibition Tests for Reverse Osmosis Membranes]

### Test Example 1, Comparative Test Examples 1 and 2

Tests for confirming the slime inhibitory effect on reverse osmosis membranes were conducted using the method described below.

### (Test Conditions)

Test Water: Sagamihara well water (dechlorinated, bacterial count: 2×10³ CFU/mL) containing 1 mg/L of added acetic acid
Water temperature: 20±2° C.
pH: 7.1±1
Reverse osmosis membrane: a four-inch reverse osmosis membrane element ESPA2 (manufactured by Nitto Denko Corporation)
Reagent: in Comparative Test Example 1, no slime inhibitor was added, in Comparative Test Example 2, a stabilized hypobromous acid composition described below was added to the water to be treated in sufficient amount to achieve a total chlorine concentration of 0.9 mg/L, and in Test Example 1, an iodine-based oxidizing agent (7) with the formulation (% by mass) shown in Table 1 that had been prepared using the same method as that described above for the iodine-based oxidizing agent (3) was added to the water to be treated in sufficient amount to achieve a total chlorine concentration of 0.25 mg/L.
Addition method: with the addition period set to 180 minutes and the non-addition period set to 1,260 minutes, operations were conducted with the addition period and the non-addition period repeated in a sequential manner.

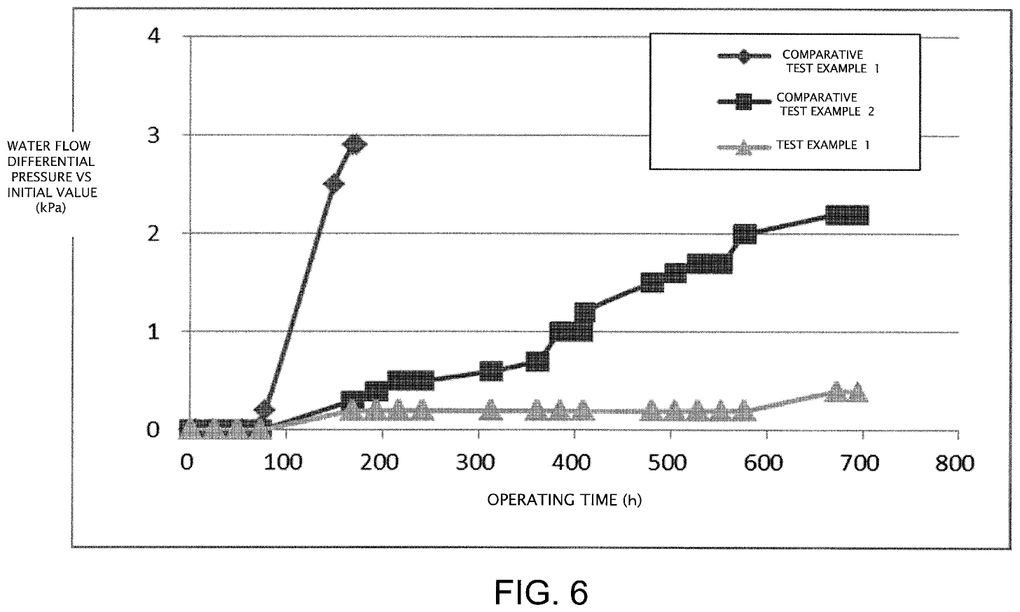

Testing was conducted with acetic acid added to the test water being supplied to the reverse osmosis membrane, thereby accelerating the generation of slime. The addition start time for the acetic acid and the slime inhibitor was designated as 0 hours, and the increase in differential pressure following the start of addition was determined. The results are shown in FIG. 6.

In Comparative Test Example 1, when the reverse osmosis membrane was operated without adding a slime inhibitor to the test water, the differential pressure started to increase significantly from about 80 hours after the commencement of acetic acid addition, and it was clear that biofouling caused by slime formation had occurred. In Comparative Test Example 2, the differential pressure started to increase gradually from about 150 hours after the commencement of addition of the acetic acid and the slime inhibitor. In Test Example 1, no significant increase in the differential pressure was confirmed, indicating that a satisfactory slime inhibitory effect had been achieved, and the reverse osmosis membrane rejection rate (%), determined as [(1−(permeate conductivity/feed water conductivity))×100], exhibited an initial value of 98.5% and a value following test completion of 98.5%, with no decrease being observed.

### [Relationship Between Concentrate Total Residual Chlorine and Water Flow Differential Pressure]

### Test Example 2, Comparative Test Example 3

Using the method described below, testing was conducted to confirm the relationship between the concentrate total residual chlorine and the water flow differential pressure.

### (Test Conditions)

Test Water: Sagamihara well water (dechlorinated, bacterial count: 2×10³ CFU/mL) containing 1 mg/L of added acetic acid
Water temperature: 20±2° C.
pH: 7.1±1
Reverse osmosis membrane: a four-inch reverse osmosis membrane element ESPA2 (manufactured by Nitto Denko Corporation)
Reagent: in Comparative Test Example 3, no slime inhibitor was added, and in Test Example 2, the iodine-based oxidizing agent (7) was used.
Addition method: operations were conducted with the addition period set to 180 minutes and the non-addition period set to 1,260 minutes.
Reagent concentration: during the addition period, total chlorine concentration immediately prior to introduction to the reverse osmosis membrane was 0.25 mg/L.
Measurement of total residual chlorine concentration in concentrate: the measured value (mg/L as Cl₂) about 60 minutes after the start of the addition period was used.

TABLE 4

| | Total residual | Water flow |
|---|---|---|
| | chlorine | differential pressure |
| | concentration in | (increase from initial |
| | concentrate [mg/L] | value) [kPa] |
| Comparative Test | 0 | 1 |
| Example 3 | | |
| Test Example 2-1 | 0.05 | 0.5 |
| Test Example 2-2 | 0.1 | 0.1 |
| Test Example 2-3 | 0.2 | 0 |

In Comparative Test Example 3, when operations were conducted without adding a slime inhibitor and with the total residual chlorine concentration in the concentrate at 0 mg/L, the increase in the water flow differential pressure from the initial value was 1 kPa, indicating that the differential pressure had increased due to slime formation. In Test Examples 2-1 and 2-2, when operations were conducted with the total residual chlorine concentration in the concentrate at 0.05 mg/L and 0.1 mg/L respectively, the increases observed in the water flow differential pressure from the initial value were 0.5 and 0.1 kPa respectively, confirming suppression of the differential pressure increase caused by slime formation. In Test Example 2-3, when operations were conducted with the total residual chlorine concentration in the concentrate at 0.2 mg/L, there was almost no increase in the water flow differential pressure from the initial value, indicating that any differential pressure increase caused by slime formation had been effectively inhibited. It is thought that by conducting operational control with the total residual chlorine concentration in the concentrate maintained at a value of at least 0.05 mg/L, and preferably 0.1 mg/L or greater, stable operations can be conducted continuously with good inhibition of slime formation.

### Text Example 3

Testing to confirm the permeation of iodine was conducted using the method described below.

### (Test Conditions)

Test Water: Sagamihara well water (dechlorinated)
Test Device: Reverse osmosis membrane element test device
Reagent: Iodine-based oxidizing agents (7), (2) and (1), which were prepared with the formulations (% by mass) shown in Table 1 by using the same method as that described above for the iodine-based oxidizing agent (3) to mix iodine and potassium iodide in a molar ratio of iodide relative to iodine (iodide/iodine) of 1.5, 2 and 3 respectively, were used.

### (Measurement of Total Iodine Atoms)

The total amount of iodine atoms was measured by ICP-MS (ELAN DRC-e ICP Mass Spectrometer, manufactured by PerkinElmer, Inc.). An adequate amount of sodium thiosulfate was added to the sample water to reduce all of the iodine, ammonia water was used to adjust the pH to a value of 9 to 10 to stabilize the ions, and measurement was then performed. A calibration curve was created using potassium iodide.

The total iodine atom concentration of a sample of the water to be treated by the reverse osmosis membrane was measured, and the measured value was multiplied by the addition time to calculate the total iodine CT value.

Total iodine CT value (mg/L·min)=(total iodine atom concentration in water to be treated (mg/L))×(addition time (min))

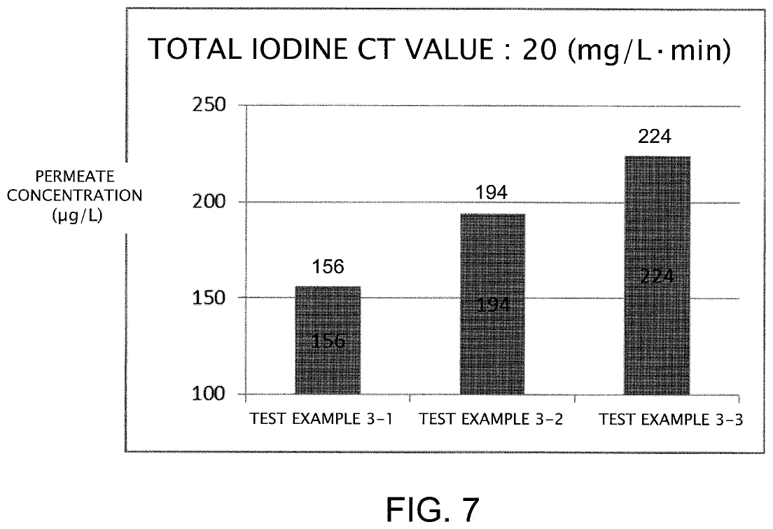

In Test Examples 3-1, 3-2 and 3-3, when the iodine-based oxidizing agents (7), (2) and (1) respectively were added continuously to achieve a total iodine CT value of 20 (mg/L·min), the amounts of iodine in the permeate were 156 μg/L, 194 μg/L, and 224 μg/L respectively. The results are shown in FIG. 7.

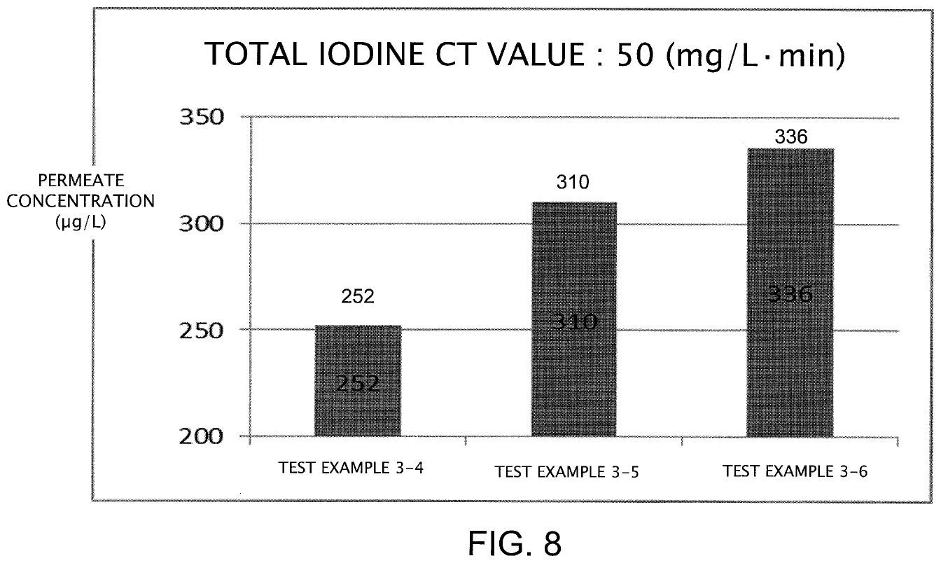

In Test Examples 3-4, 3-5 and 3-6, when the iodine-based oxidizing agents (7), (2) and (1) respectively were added continuously to achieve a total iodine CT value of 50 (mg/L·min), the amounts of iodine in the permeate were 252 μg/L, 310 μg/L, and 336 μg/L respectively. The results are shown in FIG. 8.

Regardless of whether the total iodine CT value was 20 (mg/L·min) or 50 (mg/L·min), it was evident that the iodine concentration in the permeate fell as the molar ratio of iodide relative to iodine decreased. It is clear that lowering the molar ratio of iodide relative to iodine is effective in suppressing iodine permeation.

### [Total Iodine Yield, Storage Stability]

### Test Example 4

Iodine-based oxidizing agents with the formulations (% by mass) shown in Table 1 were prepared using the same method as that described above for the iodine-based oxidizing agent (3). The formulations were prepared with [KI]/[I₂] ratios of 3, 2, 1.9, 1.8, 1.7, 1.6, 1.5, 1.4, 1.3, 1.2, 1.1 and 1 respectively. The total iodine yields are shown in Table 1. Further, the active component retention rates (%) following storage at room temperature (25° C.) or 50° C. for 30 days, 60 days and 90 days were measured to evaluate the storage stability.

For the iodine-based oxidizing agents (1) to (4), the total iodine yield was 100%, whereas the total iodine yields were 94% and 93% for the iodine-based oxidizing agents (5) and (6) respectively, and was 92% for the iodine-based oxidizing agent (7). It can be readily appreciated that a higher total iodine yield is preferred, with a value of at least 90% being favorable, and a value of 100% being the most desirable. It is evident that in order to suppresses iodine permeation while achieving a high total iodine yield, setting the molar ratio of iodide relative to iodine to a value of 1.8 is the most desirable. Further, the storage stability was extremely high for all of the iodine-based oxidizing agents, with an active component retention rate of 99% following storage at room temperature (25° C.) for 90 days and an active component retention rate of 99% following storage at 50° C. for 90 days.

### [Total Chlorine Permeation Rate Upon Intermittent Addition Operation]

### Test Example 5

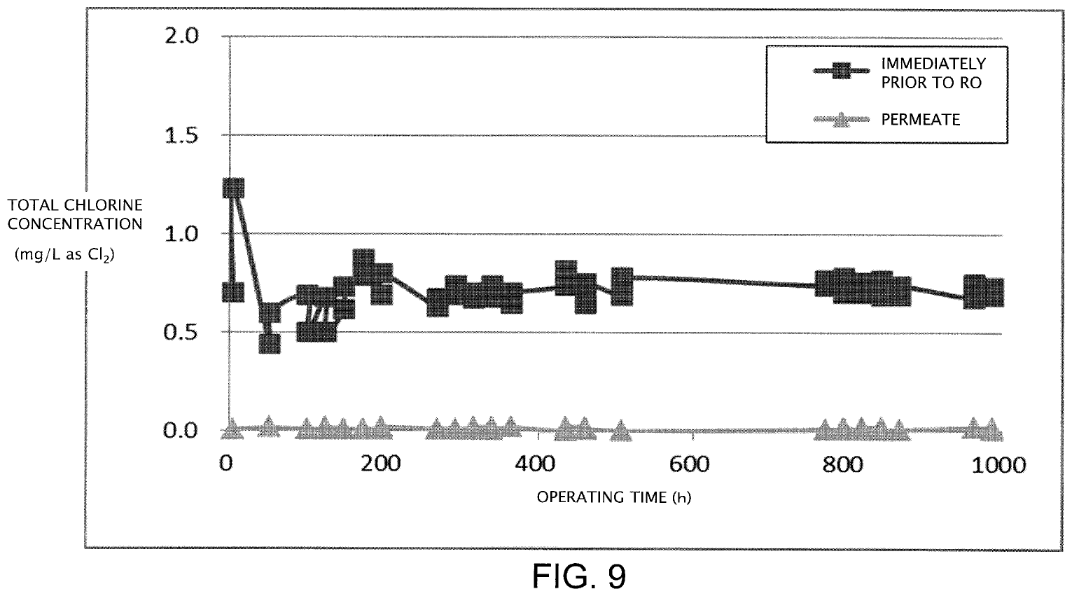

Testing to confirm the total chlorine permeation rate upon intermittent addition operation was conducted using the method described below. The results are shown in FIG. 9.

### (Test Conditions)

Test Water: Sagamihara well water (dechlorinated, bacterial count: 2×10³ CFU/mL) containing 1 mg/L of added acetic acid
Water temperature: 18±2° C.
pH: 7.1±1
Reverse osmosis membrane: a four-inch reverse osmosis membrane element ESPA2 (manufactured by Nitto Denko Corporation)
Reagent: in Test Example 5, the iodine-based oxidizing agent (3) was used.
Addition method: with the addition period set to 20 minutes and the non-addition period set to 460 minutes, operations were conducted with the addition period and the non-addition period repeated in a sequential manner.

As evidenced by the test examples, a satisfactory slime inhibitory effect was achievable with intermittent addition, the chemical cost and the amount of total iodine in the permeate were able to be reduced, and the amount of iodine permeation was suppressed and the effects on downstream facilities were able to be suppressed by ensuring that the molar ratio of iodide to iodine was within a range from 1.5 to 3.

### Test Example 6

Using the device illustrated in FIG. 2, a water treatment was conducted under the conditions listed below. The results are shown in Table 5.

### (Test Conditions)

Test Water: Sagamihara well water (dechlorinated)
Reverse osmosis membrane: a four-inch reverse osmosis membrane element ESPA2 (manufactured by Nitto Denko Corporation)
Iodine removal device: in Test Example 6, a strong anion exchanger (Amberlite IRA-400HG, OH-type, a styrene-divinylbenzene copolymer gel, harmonic mean diameter: 0.55 to 0.75 mm, total exchange volume ≥1.40 eq/L·wet resin) was used.
Reagent: in Test Example 6, the iodine-based oxidizing agent (7) was used.
Addition method: a treated water obtained by adding the iodine-based oxidizing agent to the test water was passed through the iodine removal device under conditions including SV of 50.

TABLE 5

| | | Total chlorine |
|---|---|---|
| | | concentration (mg/L) |
| Iodine removal device feed water | | 2.6 |
| Treated water | After 3 h of water flow | 0.01 |
| | After 5 h of water flow | 0.01 |
| | After 24 h of water flow | 0.01 |

In Test Example 6, the total iodine following treatment with the iodine removal device fell to 0.01 mg/L. This indicated that by using a strong anion exchanger, not only the negatively charged iodide in the iodine-based oxidizing agent, but also the uncharged iodine, was able to be removed.

### Test Example 7, Comparative Test Example 4

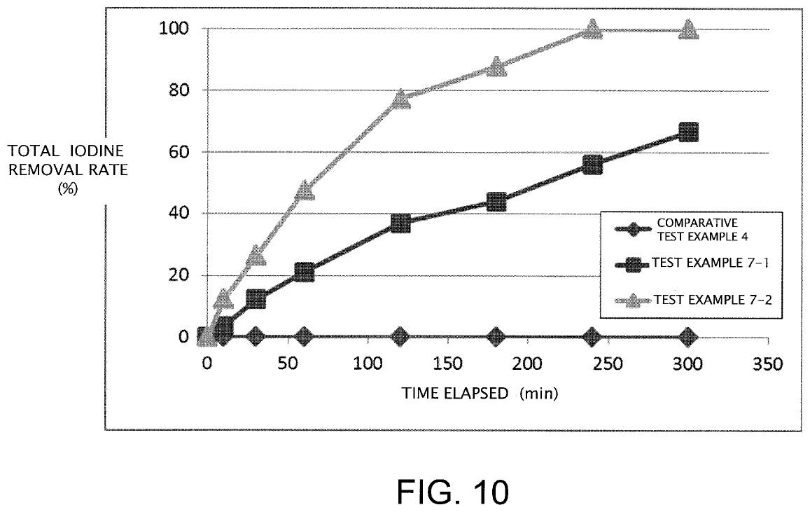

Iodine removal by stirring with a stirrer in an open system, and iodine removal that also included aeration were investigated. The results are shown in FIG. 10.

### (Test Conditions)

Test Water: pure water

Reagent: the iodine-based oxidizing agent (3)

Test water temperature: 20° C. (room temperature control)

Storage state: stored under stirring with a stirrer (Test Example 7-1: open system, Test Example 7-2: open system with aeration, Comparative Test Example 4: closed system)

It was confirmed that by conducting stirring in an open system, total iodine was eliminated. Moreover, by also performing aeration, total iodine was eliminated even more effectively. It is thought that a cooling tower and a scrubber, which represent a water treatment system having a gas-liquid mixed system, is suitable as the iodine removal device.

### [Sterilization Effect Test]

### Test Example 8, Comparative Test Examples 5 and 6

Testing to confirm the sterilization effect was conducted using the method described below.

### (Test Conditions)

Test Water: bouillon was added to Sagamihara well water (dechlorinated), and the resulting water was cultured at 30° C. for about 48 fours, yielding a bacterial count of 10⁷ CFU/mL).
Water temperature: 25° C. (room temperature control)
pH: 7.0
Reagent: in Comparative Test Example 5, chlorosulfamic acid (prepared using the method described below) was used with the effective chlorine concentration adjusted to 1.0 mg/L, in Comparative Test Example 6, a stabilized hypobromous acid compound (prepared using the method described below) was used with the total chlorine concentration adjusted to 0.25 mg/L, and in Test Example 8, the iodine-based oxidizing agent (3) was used, and added in sufficient amount to achieve total chlorine of 0.04 mg/L, 0.05 mg/L or 0.1 mg/L (total iodine of 0.14 mg/L, 0.18 mg/L or 0.36 mg/L) respectively.

### (Preparation of Chlorosulfamic Acid)

A composition was prepared by mixing 50% by mass of a 12% sodium hypochlorite aqueous solution, 10% by mass of sulfamic acid, 10% by mass of sodium hydroxide, and the balance as water. The pH of the composition was 14, and the total chlorine concentration was 6% by mass.

### (Preparation of Stabilized Hypobromous Acid Composition)

Liquid bromine: 16.9% by mass (wt %), sulfamic acid: 10.7% by mass, sodium hydroxide: 12.9% by mass, potassium hydroxide: 3.94% by mass and water: the balance were mixed together under a nitrogen atmosphere to prepare a stabilized hypobromous acid composition. The stabilized hypobromous acid composition had a pH of 14 and a total chlorine concentration of 7.5% by mass. The total chlorine concentration was measured using a multi-item water quality analyzer DR/3900 manufactured by Hach Company, and indicates the value (mg/L as Cl₂) obtained by measurement using a total chlorine measurement method (the DPD (diethyl-p-phenylenediamine) method). A detailed description of the method for preparing the stabilized hypobromous acid composition is presented below.

A 2 L four-neck flask into which nitrogen gas was injected continuously at a flow rate controlled by a mass flow controller so that the oxygen concentration inside the reaction vessel was maintained at 1% was charged with 1,436 g of water and 361 g of sodium hydroxide, and following mixing, 300 g of sulfamic acid was added and mixed, and with the flask then cooled to maintain the temperature of the reaction solution at 0 to 15° C., 473 g of liquid bromine was added, and 230 g of a 48% solution of potassium hydroxide was then added, thus obtaining the target stabilized hypobromous acid composition containing 10.7% of sulfamic acid and 16.9% of bromine expressed as mass ratios relative to the total mass of the composition, and having a ratio for the equivalent mass of sulfamic acid relative to the equivalent mass of bromine of 1.04. Measurement of the pH of the prepared solution using the glass electrode method yielded a value of 14. Measurement of the bromine content of the prepared solution using a method in which the bromine was substituted with iodine using potassium iodide and a redox titration was then performed using sodium thiosulfate revealed a value of 16.9%, which was 100.0% of the theoretical content (16.9%). Further, the oxygen concentration inside the reaction vessel during the bromine reaction was measured using an “Oxygen Monitor JKO-02 LJDII” manufactured by Jikco Ltd. The bromate concentration was less than 5 mg/kg.

The pH measurement was performed under the following conditions.

Electrode type: glass electrode

pH meter: HM-42X model, manufactured by DKK-TOA Corporation

Electrode calibration: two-point calibration was performed using the pH (4.01) of a phthalate standard solution (type 2) manufactured by Kanto Chemical Co., Inc., and the pH (6.86) of a neutral phosphate standard solution (type 2) and the pH (9.18) of a borate standard solution (type 2) manufactured by the same company.

Measurement temperature: 25° C.

Measured value: the electrode was immersed in the liquid undergoing measurement, the value following stabilization was recorded as the measured value, and the average of three measurements was recorded.

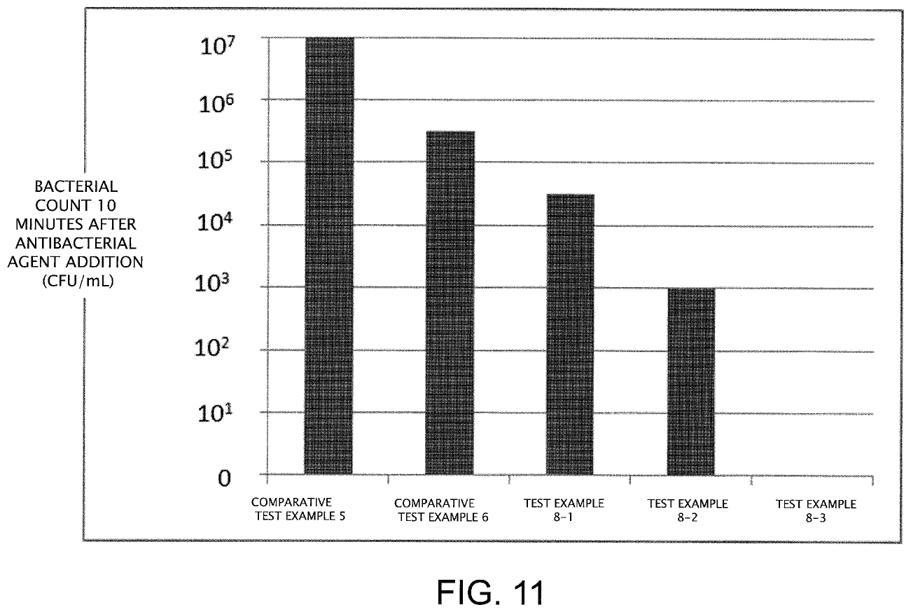

For each reagent, the bacterial count prior to the addition of the reagent to the test water was measured, the reagent was then added to the test water, and then another bacterial count measurement was conducted 10 minutes after the addition to test the sterilizing power. The bacterial count was measured using a SAN-AI Biochecker TTC (manufactured by SAN-AI OIL Co., Ltd.). The results are shown in FIG. 11.

In Comparative Test Example 5, testing was conducted using chlorosulfamic acid, and almost no sterilization effect was obtained. In Comparative Test Example 6, testing was conducted using the stabilized hypobromous acid composition, and the bacterial count decreased to 3×10⁶. In Test Examples 8-1, 8-2 and 8-3, when the iodine-based oxidizing agent was added in sufficient amount to achieve total chlorine of 0.04 mg/L, 0.05 mg/L or 0.1 mg/L respectively, the bacterial count decreased to 3×10⁴, 1×10³, and 0 respectively, indicating a powerful sterilization effect. The fact that a powerful sterilization effect was displayed even with an extremely short contact time of 10 minutes indicated the possibility that intermittent addition with a shortened reagent addition time could still be effective.

As described above, in a water treatment that uses a separation membrane and a downstream reverse osmosis membrane, by utilizing the simple method described in the examples of adding an iodine-based oxidizing agent to the separation membrane, slime generation was able to be inhibited in both the separation membrane and the reverse osmosis membrane.

### REFERENCE SIGNS LIST

1, 2, 3: Water treatment device
4, 5: Water treatment system
10: Water to be treated tank
12, 64: Filtration treatment device
14: Reverse osmosis membrane treatment device
16: Water to be treated line
18: Water to be treated supply line
20, 72: Filtration treated water line
22, 32: Permeate line
24, 34: Concentrate line
26, 54, 76: Iodine-based oxidizing agent addition line
27, 29: Line
28: Iodine removal device
30, 84: Treated water line
31: Second reverse osmosis membrane treatment device
36: Biological treatment device
38: Biologically treated water tank
40, 66: Raw water line
42: Biologically treated water line
50: Biological treatment system
60: Sand filtration device
62: Filtered water tank
68: Filtered water line
70: Filtered water supply line
74: Reducing agent addition line
78: Ion removal device
80: Membrane filtration device
82: Ion removal treated water line

1. A water treatment method comprising:
adding an iodine-based oxidizing agent to a water to be treated,
subjecting the water to be treated obtained by the iodine-based oxidizing agent addition to a filtration treatment using a separation membrane, and
separating a filtration treated water obtained by the filtration treatment into a permeate and a concentrate using a reverse osmosis membrane.

2. The water treatment method according to claim 1, wherein
the iodine-based oxidizing agent comprises water, iodine and an iodide.

3. The water treatment method according to claim 1, wherein
during the iodine-based oxidizing agent addition, a total iodine CT value (mg/L·h) represented by (total iodine within the water to be treated (mg/L))×(addition time (h) for the iodine-based oxidizing agent) is not more than 1.25 (mg/L·h).

4. The water treatment method according to claim 1, wherein
during the iodine-based oxidizing agent addition, intermittent addition is performed by providing:
an addition period during which the iodine-based oxidizing agent is added to the water to be treated, and
a non-addition period during which the iodine-based oxidizing agent is not added to the water to be treated.

5. The water treatment method according to claim 4, wherein
the addition period is a continuous period of at least 10 seconds but not longer than 3 hours, and the non-addition period is a continuous period of at least 5 seconds but less than 48 hours.

6. The water treatment method according to claim 1, wherein
a membrane pore size of the separation membrane is 0.01 μm or greater.

7. The water treatment method according to claim 1, further comprising:
removing iodine components from within the permeate.

8. The water treatment method according to claim 7, wherein
during the iodine removal step, at least one of activated carbon and an anion exchanger is used.

9. A slime inhibitor for membranes which comprises water, iodine and an iodide.

10. The slime inhibitor for membranes according to claim 9,
having a pH of at least 3 but not more than 9.

11. The slime inhibitor for membranes according to claim 9, wherein
total iodine is at least 3% by mass.

12. The slime inhibitor for membranes according to claim 9, wherein
a molar ratio of the iodide relative to the iodine is within a range from 1 to 1.9.

13. A water treatment device comprising:
an iodine-based oxidizing agent addition line for adding an iodine-based oxidizing agent to a water to be treated,
a filter for subjecting the water to be treated obtained in the iodine-based oxidizing agent addition line to a filtration treatment using a separation membrane, and
a reverse osmosis membrane for separating a filtration treated water obtained by the filter into a permeate and a concentrate using the reverse osmosis membrane.
